(19) United States
(12) Patent Application Publication
(10) Pub. No.: US 2020/0381789 A1
(43) Pub. Date: Dec. 3, 2020

(54) SCALABLE DOUBLE-SIDED BATTERY MODULE

(71) Applicant: NIO USA, Inc., San Jose, CA (US)

(72) Inventors: Adam H. Ing, San Francisco, CA (US); Alexander J. Smith, Saratoga, CA (US); Shubham Saurav, San Jose, CA (US)

(21) Appl. No.: 16/424,106

(22) Filed: May 28, 2019

(51) Int. Cl. H01M 10/6554; H01M 10/613; H01M 10/6556; H01M 10/625; H01M 2/10; B60L 50/64

(52) U.S. Cl. CPC H01M 10/6554; H01M 10/613; H01M 10/6556; H01M 2220/20; H01M 2/1077; B60L 50/64; H01M 10/625

(57) ABSTRACT

An energy storage device that includes energy storage cells, each of the energy storage cells having a top side and a bottom side, where sets of the energy storage cells are arranged in a pattern with the top sides of each of the energy storage cells being adjacent to one another; and a coldplate positioned between two of the sets of the energy storage cells, where the energy storage cells are mechanically connected to the coldplate on opposing sides of the coldplate.

### FIELD

The present disclosure is generally directed to energy storage devices, in particular, toward batteries and battery modules for electric vehicles.

### BACKGROUND

In recent years, transportation methods have changed substantially. This change is due in part to a concern over the limited availability of natural resources, a proliferation in personal technology, and a societal shift to adopt more environmentally friendly transportation solutions. These considerations have encouraged the development of a number of new flexible-fuel vehicles, hybrid-electric vehicles, and electric vehicles, and the demand for high performance batteries, such as lithium-ion cells, has increased.

Lithium-ion cells are not only used in vehicles, they are also found in many applications requiring high energy and high power densities. This is because individual cells can be electrically interconnected and placed together to provide high volumetric and gravimetric efficiency battery modules. These battery modules can likewise be electrically interconnected and placed together to meet energy requirements for specific applications. Important features of the modules include their integrity and reliability as well as their ability to meet volumetric and energy demands. Another important design consideration is the gravimetric energy density of the battery modules because any increases in gravimetric energy density (e.g., increases in the energy of the battery module in comparison to the weight of the battery module) are advantageous to improve the performance of the battery modules.

Therefore, there is a need to develop improved methods and systems for battery modules. The present disclosure satisfies these and other needs.

### BRIEF DESCRIPTION OF THE DRAWINGS

FIG. 1 shows a top view of an interior of a module in accordance with embodiments of the present disclosure;

FIG. 2 shows a first side view of an interior of a module in accordance with embodiments of the present disclosure;

FIG. 3 shows a second side view of an interior of a module in accordance with embodiments of the present disclosure;

FIG. 4 shows a rear view of a module in accordance with embodiments of the present disclosure;

FIG. 5 shows a front view of an interior of a module in accordance with embodiments of the present disclosure;

FIG. 6 shows a first module configuration in accordance with embodiments of the present disclosure;

FIG. 7A shows an assembly method of a second module configuration in accordance with embodiments of the present disclosure;

FIG. 7B shows the second module configuration in accordance with embodiments of the present disclosure;

FIG. 8 shows components of a coldplate in accordance with embodiments of the present disclosure;

FIG. 9 shows components of an assembled module in accordance with embodiments of the present disclosure;

FIG. 10A shows a circulation within a coldplate in accordance with embodiments of the present disclosure;

FIG. 10B shows components of the second module configuration in accordance with embodiments of the present disclosure;

FIG. 10C shows assembled coldplates with manifold components in accordance with embodiments of the present disclosure;

FIG. 11 shows flex circuit mechanical and electrical connections in accordance with embodiments of the present disclosure;

FIG. 12A is an illustrative diagram of portions of a flex circuit in accordance with embodiments of the present disclosure; and

FIG. 12B is an illustrative schematic of flex circuit connector pinouts in accordance with embodiments of the present disclosure.

### DETAILED DESCRIPTION

Battery modules with cylindrical cells are typically built with the cells arranged in a pattern within a structure and are built to a standard size using a standard template. Sometimes, the cells will be arranged to be standing vertically within the module. This is advantageous when the height of the battery pack is driven by other factors (i.e., vehicle height, passenger cabin space, etc.). However, for applications that require different sizing of the battery modules or flexibility in the sizing of the battery modules, it would be helpful to have battery modules where the cells may be arranged in new patterns and where the modules are scalable. For example, for packages that have flexibility in height, it would be advantageous to turn the cells on their side to obtain greater flexibility in the battery pack height. In addition, as cells are in use, heat generated can negatively affect the cells if the cells become too hot. For example, heat generated during charging, and in particular fast charging, of battery modules can lead to reduced battery (cycle and calendar) life. To reduce the amount of heat generated within battery modules, modules with improved heat transfer characteristics are desired.

Currently, various designs are used to hold cells within a module. For example, structures with a honeycomb design can be used that are pre-formed structures where the lithium-ion cells are inserted into the open holes within the structure. Also, a framework can be placed around the cells where the framework is filled in with a thermally conductive, electrically insulating foam. However, current designs hold cells in an upright position and are thus limited in flexibility in the height direction. It would be advantageous to have module designs that provide greater dimension flexibility (including an ability to scale design dimensions) and improved energy density (e.g., by improving volumetric packaging density) while meeting or improving upon any thermal requirements for the cells.

It is generally advantageous to increase the gravimetric energy density of cells and battery modules (as this value directly translates to the gravimetric energy density of battery packs) by increasing the capacity of the cells and/or module in comparison to their weight to improve the performance of the battery (e.g., by improving the performance of the cells and/or module). Increases in gravimetric energy density have conventionally been difficult to achieve. Reasons for this include the fact that it can be difficult to decrease the weight of the battery module. As the battery is also one of the largest, heaviest, and most expensive single components of an electric vehicle, any reduction in size and/or weight can advantageously have significant cost savings.

Embodiments of the present disclosure will be described in connection with electrical energy storage devices, and in some embodiments, in connection with the construction and structure of components making up a battery module.

Although embodiments described herein may be described with respect to an electric vehicle, the present disclosure is not so limited. Various embodiments of the present disclosure can apply to any type of machine using a battery, for example mobile machines including but not limited to, vertical takeoff and landing vehicles, aircraft, spacecraft, watercraft, and trains, among others.

An electrical energy storage device for a vehicle may include at least one battery including a number of battery modules electrically interconnected with one another to provide electromotive force for the electrical drive system of a vehicle to operate. Each battery module in the at least one battery can include any number of battery cells contained and/or arranged within a structure.

Embodiments disclosed herein provide a scalable battery module design, including an ability to have improved integration and package density. For example, cells may be placed within a module horizontally and this provides several advantages. For example, by placing the cells horizontally, this improves the ability to adjust a height of the module. This is because the height may be adjusted based on adjusting a number of cells used in the height direction, and also because the height may be further adjusted because of an ability to stack multiple modules on top of one another in the height direction (e.g., a vertical direction). Further, when the cells are positioned horizontally and stacked in a height direction, the cells may also be expanded in the horizontal direction by changing an amount of cells (and a size of the coldplate, if necessary). Thus, the dimensions of the module are advantageously flexible in multiple directions. When the modules disclosed herein are stacked, they may be stacked in a height direction. For example, using an x-y-z coordinate system, the design of the module may be adjusted in the y-direction and z-direction by adjusting amounts of cells included within a single module. Also, the modules can be placed adjacent to one another to scale the design in the x-direction.

In addition, by placing cells horizontally within a module, the cells may be in contact with a coldplate on multiple sides of the coldplate (e.g., so that the coldplate is positioned between groups of cells). Such a configuration (e.g., having cells on multiple sides of a coldplate) can reduce the overall weight of the module due to having twice as many cells being in contact with a same sized coldplate as what is conventionally done (e.g., conventionally cells may be placed on only one side of a coldplate with the cells in a vertical position). In addition, multiple sets of coldplates with cells position on multiple sides of each coldplate may be placed adjacent to one another within a module to provide further advantages including but not limited to reduced cost, reduced weight, and reduced maintenance requirements.

The modules disclosed herein may use a flexible circuit (“flex circuit”) to connect the cells together and to connect the cells to other components of the module. This flex circuit advantageously functions as a low-profile flexible busbar that provides various features such as providing a dielectric barrier, providing a temperature sensing interface, providing a voltage sensing interface, and providing fixturing for laser welding, among others. The flex circuit may comprise a thin sheet of copper that is laminated between two flat sheets (e.g., dielectrics), for example.

The battery modules disclosed herein can advantageously be used to replace other modules. For example, they can be used as a drop-in replacement for prismatic (e.g., Verband der Automobilindustrie (“VDA”)) modules. When used as a drop-in replacement for VDA modules, the modules disclosed herein can advantageously increase energy density. For example, the modules disclosed herein may provide up to about thirty percent energy in a same package space when the cylindrical cells have about a thirty percent or higher volumetric energy density. This is also advantageous because conventional modules may be designed to meet specific size requirements that the modules of the present disclosure may be scaled to meet, such as a size of about 355 inches by about 151 inches by about 108 inches for VDA modules.

The coldplates disclosed herein can be comprised of multiple plates that are connected together to form the coldplate. In various embodiments, the coldplates can be connected together by a snap feature to lock compression snap components together (e.g., by a snap function facilitated by diameter mismatches of the snap components) to hold the plates of the coldplate together. The compression snaps may be distinct components (e.g., components that are separate from components of the coldplate and carrier), or portions or all of the compression snaps may be integrated into other components of the module, such as any of the plates of the coldplate or parts of the carrier. The compression snaps may use compression limiters that are positioned adjacent to surfaces of the coldplate, or between each interface of the plates of the coldplate. Similarly, the coldplate compression limiters may be distinct components, or they may be integrated into one or more of the plates of the coldplate or parts of the carrier. The compression snaps may be single use fastening components. Whether the compression snaps and compression limiters are separate components that are assembled together with the coldplate, or they are integrated into other components, the compression snaps may snap connect for a compression lock.

Advantageously, the compression snap feature may take both a compressive and tensile load. Also, the compression snap feature may be accomplished by a diameter mismatch between the compression snaps. For example, if the compression snap feature components are integrated into other components, then the diameter mismatches may be between the components in which the compression snap feature components are located.

The configurations disclosed herein may provide improved mounting of the battery pack, or components of the battery pack. For example, mounting may be done in the middle of the module and rods may be used to connect components through multiple coldplates. In some aspects, the rods may extend through the compression limiters.

Embodiments disclosed herein may use manifolds to connect multiple coldplates within a module or battery pack. Portions of the manifold may be integrated into the coldplates; for example, by using hose barbs extending from the coldplates on which to attach portions of the manifold. This also advantageously allows for improved cooling area and thermal performance of the coldplates with the same fluid being used for all of the coldplates as the coldplates are connected in parallel. Such embodiments may be used in addition with improved thermal interfaces between the cells and coldplates. For example, a dielectric layer and/or glue may be used between the cells and coldplates to provide improved thermal performance.

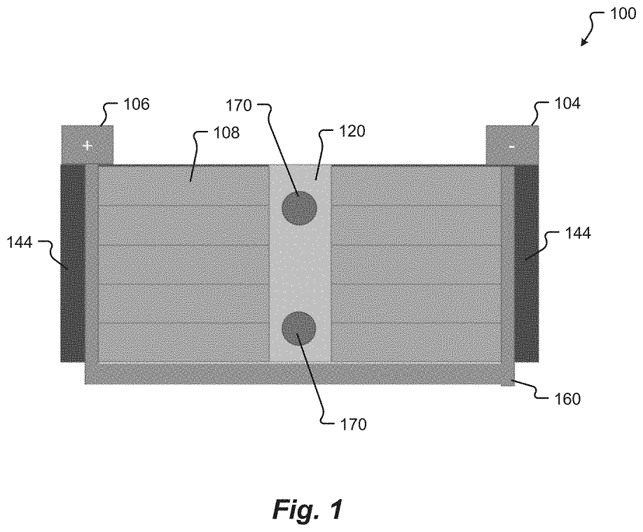

FIG. 1 shows a top view of an interior of a module in accordance with embodiments of the present disclosure. In the module 100 of FIG. 1, the module 100 is a rectangular box shape, with six sides and cells 108 contained within the module 100. The cells 108 are arranged horizontally on either side of a cold plate 120 and the cells 108 on both sides of the cold plate 120 are connected to the cold plate 120. The cells 108 may be arranged so that cells 108 located adjacent to one another on a same side of the coldplate all have a same orientation. For example, the top sides of the cells may be adjacent to each other so that the bottom sides of the cells are adjacent to each other (and in contact with the coldplate). As used herein, the term “top side” (also referred to as “top portion” and “top part”) refers to a portion of the cell that is closer to a header of the cell. The term “bottom side” (also referred to as “bottom portion” and “bottom part”) refers to a portion of the cell that is further from the header of the cell. Thus, the top side is opposite to the bottom side. If the cells are positioned horizontally, as shown in FIG. 1, then the top sides of the cells will be on a same horizontal level as the bottom sides of the cells (e.g., they are perpendicular to a vertical direction).

The view in FIG. 1 shows mounting points 170 where a top cover would be attached to the module 100; however, the top cover is not shown. Side covers 144 enclose a flex circuit 160 and the cells 108 within the module 100 on the sides of the module 100. The mounting points 170 may be located on a center line of the module 100 along where the coldplate 120 is located. The positive terminal 106 and the negative terminal 104 are located at the front side of the module 100 and are connected to the flex circuit 160.

The flex circuit 160 wraps around the rear of the module 100 to connect the battery cells 108 electrically in parallel or in series and also provides a dielectric barrier (e.g., electrically insulative tape) to prevent undesirable electrical connections within the module 100. The flex circuit 160 can provide additional features, such as a temperature sensing interface, a voltage sensing interface, and fixturing for laser welding, for example.

Advantageously, because the cells 108 are oriented horizontally, they are able to be stacked in the vertical direction, and because the cells 108 are stacked in the vertical direction within the module 100, it is possible to adjust a height of the module 100 to a desired height. In addition, due to the cold plate 120 transferring thermal energy to and from cells 108 on either side of the cold plate 120, the cold plate 120 can advantageously provide thermal transfer benefits to more of the cells 108 than in a conventional arrangement (e.g., where cells would be arranged to be in contact with only one side of a cold plate), thereby improving thermal performance of the module while improving gravimetric energy density. In addition, the flex circuit 160 provides a low-profile flexible busbar that provides various features such as a dielectric barrier, a temperature sensing interface, a voltage sensing interface, and fixturing for laser welding, among others. In addition, because the flex circuit 160 is low-profile, it also improves the gravimetric energy density of the module 100 by decreasing an amount of materials required within the module 100.

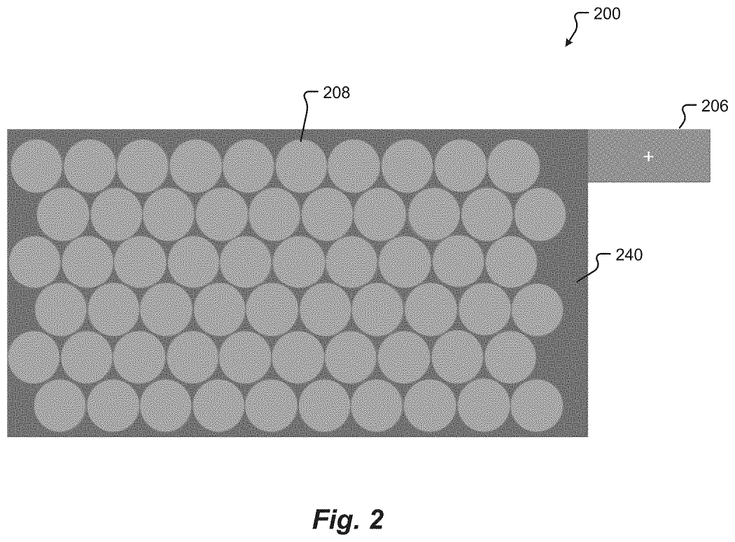

FIG. 2 shows a first side view of an interior of a module 200 in accordance with embodiments of the present disclosure. In FIG. 2, module covers are not shown and the interior of the module 200 is exposed. The cells 208 are arranged horizontally in a pattern that allows for a maximum number of cells 208 to be incorporated within the interior volume of the module 200. In FIG. 2, the top sides of the cells 208 are visible and the bottom sides are not because they are located directly behind the top sides. The cells 208 may be held in place by a carrier 240, which may be made of any suitable design and material(s) such as plastic with a gap filler pad between the cells 208 and the coldplate 240. Alternatively, or in addition, the cells may be held in place by an adhesive such as a glue, which may be thermally conductive and in contact with a dielectric layer on the coldplate 240. In some aspects, the cells may be placed as close to the coolant (e.g., the fluid within the coldplate 240) as possible to improve thermal efficiency within the module. The cells 208 may have one or more material(s) between the cells 208 and the coldplate (not shown because it is behind the carrier 240 in this view), such as a dielectric barrier. A similar or identical arrangement of cells 208 may be present on the other side (e.g., opposite from what is visible in FIG. 2) of the coldplate 240. The positive terminal 206 (e.g., the busbar terminal) is located on an exterior top side of the module 200.

As shown in FIG. 2, the compact arrangement of the cells 208 (on both sides of the coldplate 240) advantageously increases the gravimetric density of the module by decreasing the materials needed for transferring thermal energy to and from the cells 208. In addition, if the module 200 is used to replace a typical prismatic (e.g., a VDA Plug-in Hybrid Electric Vehicle 2 (PHEV2)) battery module, improved energy density may be achieved over the typical prismatic battery module. For example, if the prismatic battery module is in the 120 mm height range, a module of the present disclosure may satisfy the height requirement because six of 21700 cells packed in a hexagonal format is about 120 mm tall. Thus, modules of the present disclosure may advantageously be adjusted to meet dimensional requirements to be used as replacements for conventional battery modules, including typical prismatic battery modules. In addition, reduced size of the cells (e.g., height from a top side of the cell to the bottom side of the cell) may further improve the thermal functioning of the module because the cold plate has a shorter distance to cool (e.g., the reduced size) than in conventional designs (including prismatic VDA battery modules).

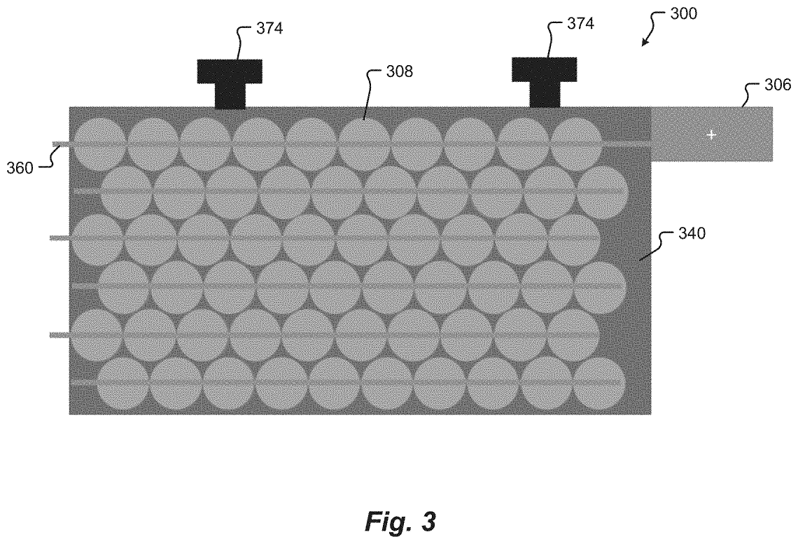

FIG. 3 shows a second side view of an interior of a module 300 in accordance with embodiments of the present disclosure. In FIG. 3, module covers are not shown and the interior of the module 300 is exposed. Similar to the configuration shown in FIG. 2, the cells 308 are arranged in a pattern that allows for a maximum number of cells 308 to be incorporated within the interior volume of the module 300. The cells 308 are held in place by a carrier 340, which may be made of any suitable design and material(s). The positive terminal 306 is located on an exterior top side of the module 300 and bolts 374 are located at a top side of the module to hold a module cover (not shown) in place.

In this view of the interior of the module, the flex circuit 360 is shown connecting the cells 308. The flex circuit 360 may be a low-profile and flexible connector that connects the cells 308 electrically and mechanically. The arrangement of the flex circuit 360 may connect the cells 308 in various patterns. Although not shown in FIG. 3, the flex circuit 360 wraps around to the other side of the module 300 to electrically connect all of the cells within the module 300 and connects to the positive terminal 306. Although not shown, additional components may be used in the modules disclosed herein. For example, bolts can run horizontally through the module (e.g., from cover to cover) if additional structure is required, for example to keep the cells adhered to coldplate.

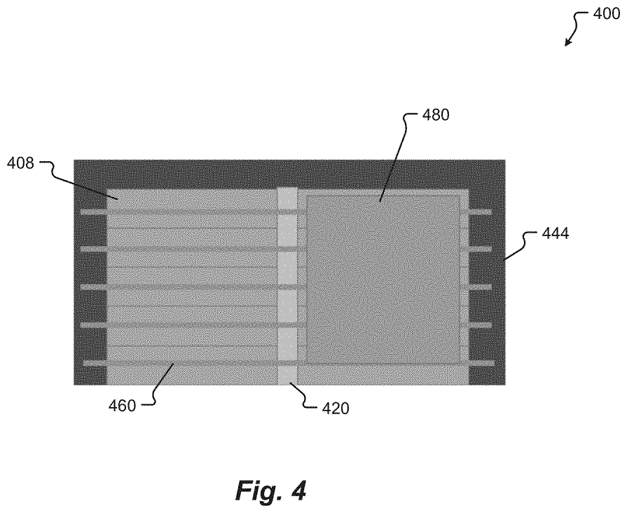

FIG. 4 shows a rear view of a module 400 in accordance with embodiments of the present disclosure. In the rear view, the cells 408 are shown positioned horizontally with a cold plate 420 in between two sets of cells 408. Covers 444 for the module 400 are on the top and sides of the module 400 and the flex circuit 460 is shown wrapping around the rear of the module 400 to connect the cells 408. Although a cover on the rear is not shown, a cell monitoring unit (CMU) 480 is shown positioned on the rear of the module 400. The CMU 480 contains circuits monitoring and controlling functions of the module 400, such as measuring and balancing cell voltages. The CMU may include a printed circuit board (PCB) that may be potted/conformal coated. The coated PCB may advantageously provide a cover that is waterproof and has mechanical protection (e.g., is shock proof or shock resistant) while it is cheaper and lighter than other options.

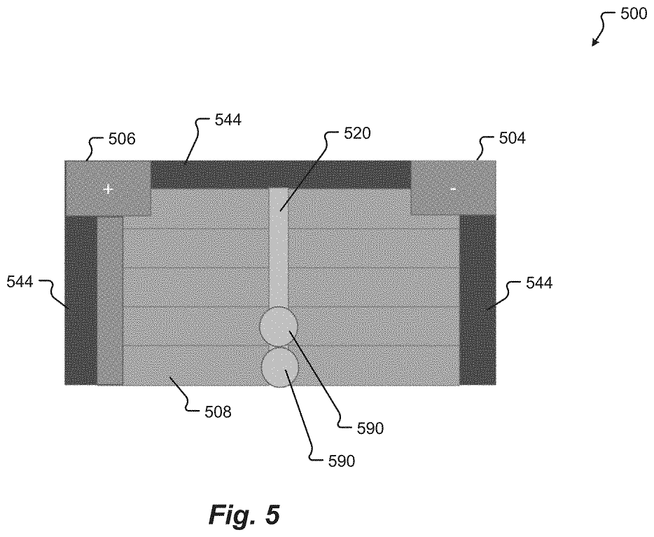

FIG. 5 shows a front view of an interior of a module 500 in accordance with embodiments of the present disclosure. In FIG. 5, the cells 508 are arranged horizontally on either side of the cold plate 520. Coolant ports 590 on the front of the module underneath the module terminals (negative terminal 504 and positive terminal 506) and provide an inlet and outlet to the cold plate 520 for fluid to circulate within the cold plate 520 to transfer thermal energy to the cells 508. The coolant ports 590 are advantageously positioned lower than (e.g., below in a vertical direction) the electrical terminals (e.g., 504 and 506) to prevent condensation from dripping on the electrical terminals (e.g., 504 and 506). Although the front cover is not shown, module covers 544 are shown on the top and side surfaces of the module 500.

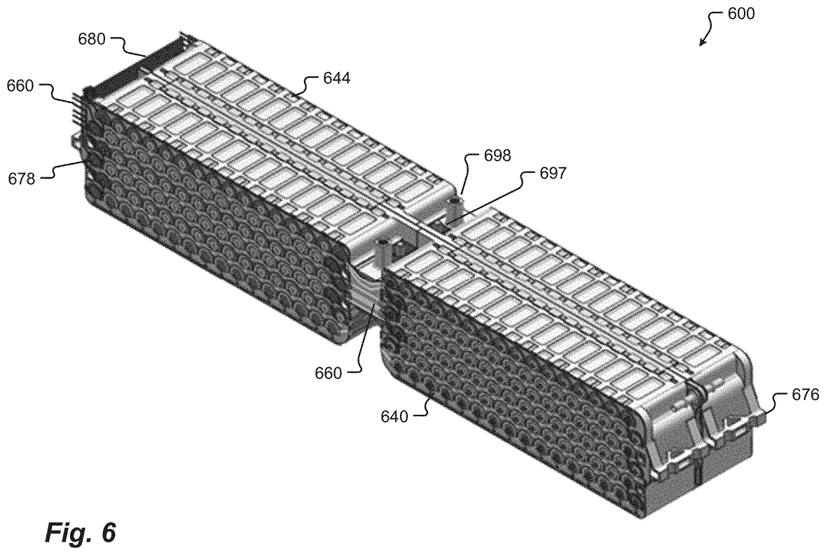

FIG. 6 shows a first module 600 configuration in accordance with embodiments of the present disclosure. In the module 600, the cells are held in place and contained within carriers 640 that have module covers 644. In the configuration of FIG. 6, the module 600 has four quadrants (e.g., two quadrants that are non-terminal quadrants (e.g., quadrants each containing sets of cells not on terminal sides of the module 600) and two quadrants that are terminal quadrants (e.g., quadrants each containing sets of cells on terminal sides of the module 600)). A flex circuit 660 electrically connects the cells within the module 600 by being connected between all four of the quadrants. The module covers 644 may be connected together by pack compression bolts 678, crossmember mounting 676, and cover mounting points 697. A CMU 680 is located at an end of the module 600. In a middle of the module, in between sets of quadrants, are high voltage terminals 698. The CMU terminal may be a 22-pin molex connector, and the high voltage terminals 698 may be configured using M8 bolts, for example.

An illustrative assembly process for one of the quadrants may be performed as follows. The assembly may include placing the top of a carrier on an assembly surface to expose the cavity within the carrier (e.g., so that the opening of the carrier is exposed because the bottom opening of the carrier is above the top of the carrier). A foam structure is inserted into the carrier cavity. A UV curable adhesive is applied to a bottom carrier substrate prior to flush fitting the bottom carrier attachment onto the carrier (e.g., with the UV-cure adhesive pre-applied). The applied adhesive may then be UV cured while the flush fit is maintained. A UV curable adhesive may then be applied to the cell cavity substrate at a top polymer level and then the cells may be inserted into the carrier with the pre-applied UV-cure adhesive. The UV curable adhesive may then be applied to the other side of the carrier (e.g., the top surface of the assembly) and the assembly may be UV cured on both sides. Prior to assembling the quadrant into the module, the surfaces may be cleaned (e.g., by a plasma cleaning) and TIM may be applied to the bottom surface, taking care to apply the TIM to all exposed metal surfaces on the bottom surface.

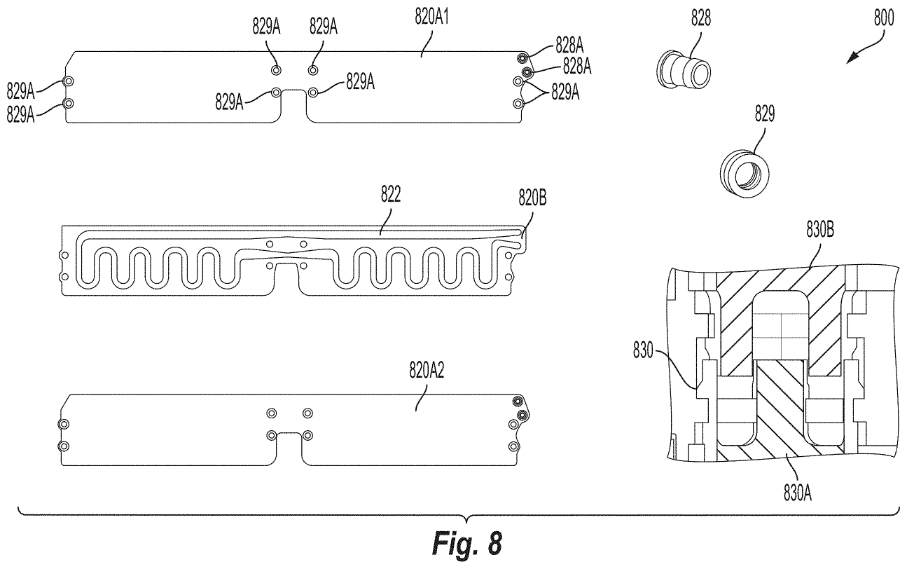

As an illustrative example, module 600 can hold 21700 cylindrical cells (a configuration of 12S32P (384 cells)), with an energy density of 240 Wh/kg and a volumetric energy density of 426 Wh/L. The module 600 may provide a nominal voltage of 43.6 V with a minimum voltage of 36 V and a maximum voltage of 50.4 V. The module 600 may provide 6.7 kWh of energy with a mass of 28.1 kg. The dimensions of the module 600 may be about 821 inches (length) by about 150 inches (width) and 129 inches (height). The thermal interfaces may be SAE J2044 quick disconnect (e.g., 8 mm) types. The quadrants may be attached to either side of a coldplate and further assembled as discussed in relation to FIGS. 8-12B.

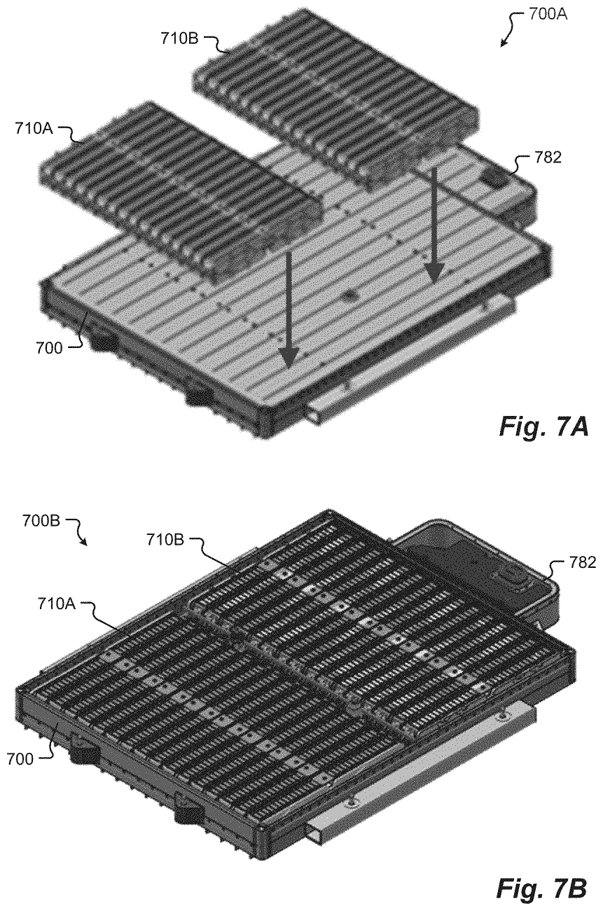

FIG. 7A shows an assembly method of a second module configuration 700A in accordance with embodiments of the present disclosure. In the assembly method of FIG. 7, two sets of battery packs 710A and 710B are placed adjacent to one another within a module 700. A battery disconnect unit (BDU) 782 is located at one end of the module 700. The BDU 782 contains contactors, fuses, and a current sensor, for example, and may be controlled by a master battery management system (BMS) hardware board together with software. The BDU 782 may contain contactors/relays to disconnect the battery from the vehicle. The BMS boards, current sensors, and fuses are also integrated into the BDU 782. The battery packs 710A and 710B may be connected using PCBs (e.g., slave BMSs) with a wiring harness.

FIG. 7B shows the second module configuration 700B in accordance with embodiments of the present disclosure. In FIG. 7B, the battery packs 710A and 710B and the BDU 782 are configured within the module 700. As an illustrative example, module configuration 700B may contain two 400 V battery packs (e.g., battery packs 710A and 710B) in a parallel configuration. The module configuration 700B may have same external interfaces and dimensions as other types of battery packs (e.g., an ES8 battery pack) with internal modifications for the configurations disclosed herein. The module configuration 700B may advantageously have a configuration of 12S32P 2P with 6,144 cells that may be 4.8 Ah 21700 cylindrical cells (GB/T) or 5.3 Ah 21700 cylindrical cells (non-GB/T) with provided energy of about 107.0 kWh for GB/T or about 118.2 for non-GB/T, respectively, to obtain an energy density of about 175 Wh/kg to about 185 Wh/kg. The nominal voltage may be about 345.6 V with a minimum voltage of about 288 V and a maximum voltage of about 403.2 V. The mass of the module configuration 700B may be about 578 kg if using an aluminum box for the module, or about 608 kg if using a steel box for the module. The interfaces may be Bayobolt swap interfaces with a 400V quick-swap connector for the high voltage and a quick-swap connector for the low voltage with a coolant quick-swap type for the thermal interfaces.

FIG. 8 shows components of a coldplate 800 in accordance with embodiments of the present disclosure. The coldplate can include coldplate outer plates 820A1 and 820A2 with a coldplate channel plate 820B that is positioned between the coldplate outer plates 820A1 and 820A2. The coldplate channel plate 820B includes channel 822 through which a fluid may flow to transfer thermal energy from the fluid to the coldplate outer plates 820A1 and 820A2 and to any components thermally connected to the coldplate outer plates 820A1 and 820A2. The components of the coldplate 800 further include coldplate ports 828, through which the fluid may be input and output to and from the coldplate channel plate 820B, with the coldplate ports 828 being located at the ends of the channel 822 after assembly.

To assemble the coldplate components 800, the coldplate channel plate 820B is positioned between the coldplate outer plates 820A1 and 820A2 and they may connect together. For example, they may be connected together by a snap feature 830 that locks compression snaps 830A and 830B together. The compression snaps 830A and 830B may be integrated into the any of the plates of the coldplate (e.g., one or more of the coldplate channel plate 820B, the coldplate outer plate 820A1, and the coldplate outer plate 820A2) and/or integrated into the carrier. The compression snaps 830A and 830B may interact with compression limiters (e.g., eight coldplate compression limiters 829) so that when the coldplate channel plate 820B is positioned between the coldplate outer plates 820A1 and 820A2, coldplate compression limiters 829 are aligned so that the snap features will hold the coldplate channel plate 820B and the coldplate outer plates 820A1 and 820A2 together. For example, the coldplate compression limiters 829 may be positioned between each interface of the plates at the coldplate compression limiter interfaces 829A (the eight compression limiter interfaces 829A are labeled on only one of the plates shown in FIG. 8 for clarity and illustrative purposes). Then, during coldplate assembly, the compression snaps 830A and 830B connect together through each of the coldplate compression limiters 829 and plates at the coldplate compression limiter interfaces 829A by sliding the compression snap 830A together with the compression snap 830B to snap connect for a compression lock.

In addition, or alternatively, compression snap feature 830, or one or more components thereof (e.g., compression snaps 830A and 830B), may be components that are separate from the carrier and used to connect the coldplate channel plate 820B and the coldplate outer plates 820A1 and 820A2 together with the coldplate compression limiters 829 positioned between each interface of the plates at the coldplate compression limiter interfaces 829A. The compression snaps 830A and 830B may be single use fastening components. Further, the coldplate compression limiters 829 may be integrated into one or more of the plates of the coldplate (e.g., coldplate channel plate 820B, coldplate outer plate 820A1, and coldplate outer plate 820A2).

As an illustrative example, any of the components shown in FIG. 8, including the plates of the coldplate (e.g., one or more of the coldplate channel plate 820B, coldplate outer plate 820A1, and coldplate outer plate 820A2), may be made from aluminum and have a thickness of about 7 mm, a length of about 804 mm, and a height of about 124.6 mm. Hose barbs (e.g., at coolant port interfaces 828A) that provide the inlet and outlet for the fluid within the coldplate channel plate 820B may have an inner diameter of about 9.5 mm. The ports may be defined as SAE J1231 and the hose size may be SAE-6 with an inner diameter of about ⅜ of an inch and an inner diameter of about 10 mm.

Advantageously, the compression snap feature 830 may be accomplished by a diameter mismatch between compression snaps 830A and 830B. For example, if the compression snap feature 830 components are integrated into one or more of the coldplate channel plate 820B, the coldplate outer plate 820A1, and the coldplate outer plate 820A2, then the diameter mismatches may be between the one or more of the coldplate channel plate 820B, the coldplate outer plate 820A1, and the coldplate outer plate 820A2 so that when the plates are connected together, they connect using a snap connection that creates a compression lock. As mentioned previously, the compression limiters 829 may also be integrated into one or more of the coldplate channel plate 820B, the coldplate outer plate 820A1, and the coldplate outer plate 820A2.

Advantageously, the assembled coldplates may have a coolant pressure drop of less than about 6 kPa (or about 1 LPM) using a coolant of 5050 glycol. The performance of the coldplate may include a change in temperature of less than about 5° C. at 100 W of the area of the coldplate that is in thermal contact with the cells (e.g., the areas between the coldplate compression limiter interfaces 829A). The coldplate compression limiters 829 can take both a compressive and tensive load and may meet a mechanical requirement to take a 500N load without any plastic deflection. The coldplate compression limiters 829 may take a compressive force during mounting with tensive and shear forces during mechanical shock and vibration.

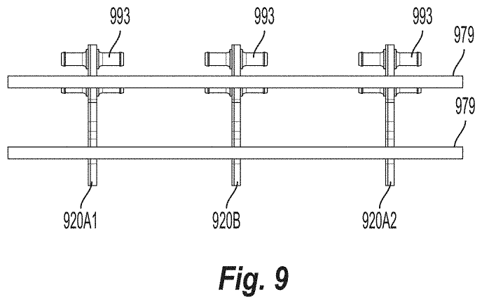

FIG. 9 shows components of an assembled module in accordance with embodiments of the present disclosure. In FIG. 9, multiple coldplates 920 are configured side-by-side, as they may be in a completed module. For example, during module assembly, compression rods 979 may be placed so that they extend through mounting holes (e.g., the eight coldplate compression limiter interfaces 829A from FIG. 8) to align the mounting holes between the multiple coldplates 920 to within a certain tolerance (e.g., aligned within about 0.2 degrees) when assembling the module. The coldplates 920 shown in FIG. 9 have hose barbs 993 that connect to the channel of the coldplate to circulate fluid within the coldplate (e.g., via the coolant port interfaces 828A as shown in FIG. 8). The hose barbs 993 may be connected to each other using manifold jumpers.

The configurations shown and discussed in relation to FIG. 9 are advantageous because they can provide improved strength and alignment for connecting coldplates within a module, and also provide a more compact module that improves gravimetric energy density. Also advantageously, and similar to how the number of cells may be adjusted to adjust the dimensions of a module as disclosed herein, various numbers of coldplates may be used in the modules of the present disclosure (including only one coldplate). This makes it possible to flexibly scale the size of the module for use in various applications, and/or to meet various design and operational requirements, as well as improve the volumetric energy efficiency.

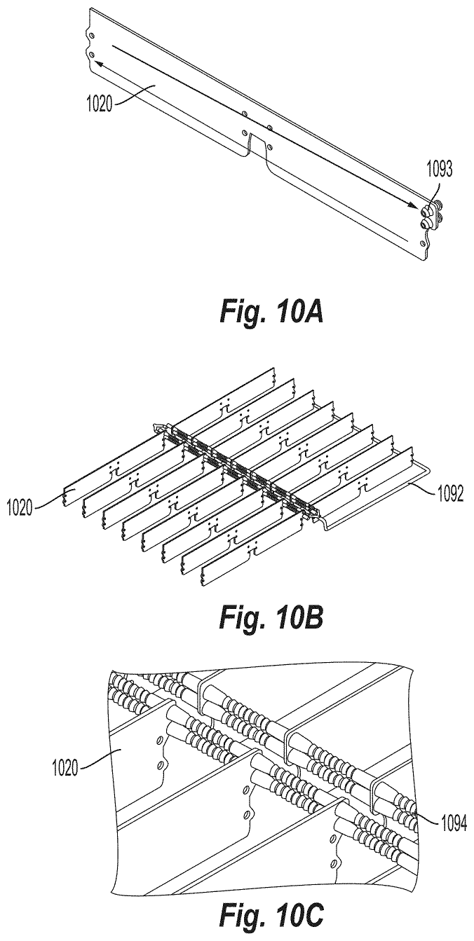

FIG. 10A shows a circulation within a coldplate in accordance with embodiments of the present disclosure. In FIG. 10A, fluid flows in and out of inlet and outlet ports 1093 and through the coldplate 1020, thereby transferring thermal energy through the coldplate 1020.

FIG. 10B shows components of the second module configuration in accordance with embodiments of the present disclosure. In FIG. 10B, multiple coldplates 1020 are arranged side-by-side and then sets of the multiple coldplates 1020 are arranged adjacent to one another. The fluid flow between the coldplates 1020 occurs through a manifold connected between the coldplates 1020 (shown in more detail in FIG. 10C). The manifold is advantageously integrated into the coldplates 1020 to simplify the design (e.g., reduce the amount of manifold lines required) and improve the volumetric energy density of the module. As shown in FIG. 10B, the fluid flows into one side of the module at one coldplate inlet port, circulates between all of the coldplates 1020, then exits the other side of the module at one coldplate outlet port.

FIG. 10C shows assembled coldplates with manifold components in accordance with embodiments of the present disclosure. In FIG. 10C, the manifold is connected between the coldplates 1020 using manifold jumpers 1094. Thus, the manifold jumpers 1094 connect the outlet from one coldplate to the inlet of another to thereby connect the fluid flow between all of the coldplates 1020. The coldplates 1020, and fluid flow between them, may be connected in any manner. There may be any number of coldplates to customize the dimensions and design of the module.

As an illustrative example, the configurations shown in FIGS. 10A-C may be used inside automotive high voltage battery packs with a coolant type of 5050 glycol, a burst pressure of about 240 kPa, and operating temperatures of—about 40° C. to about 65° C. The inlet and outlet connectors for the fluid to and from the coldplates 1020 may have an outer diameter of about 16 mm and conform to SAE J2044. In one illustrative embodiment, there may be sixteen coldplates in total, all connected in parallel with fluid flowing through an inlet and out a rear port to the next coldplate for each of the sixteen coldplates, and with the last coldplate having the outlet port capped off so that no fluid can exit. The manifold jumpers may be a single connection (e.g., expected to be connected only once and non-serviceable so that it must be cut off and replaced, if necessary). A maximum outer diameter of the manifold jumpers may be about 16 mm at the ends closest to the coldplates, with an outer diameter of about 14 mm at the center of the manifold jumper between the coldplates, an inner diameter of about 11.2 mm, and a hose length between each of the coldplates may be about 149.9 mm with a distance between the coldplates being approximately the same. The manifold jumpers may connect to ports of each coldplates via a barb design integrated into the coldplate that extends at the inlet/outlet ports to slide the manifold jumper onto in order to create a mechanical connection through which fluid may flow. The barb may have an inner diameter of at least about 11.2 mm and a maximum outer diameter of about 14 mm.

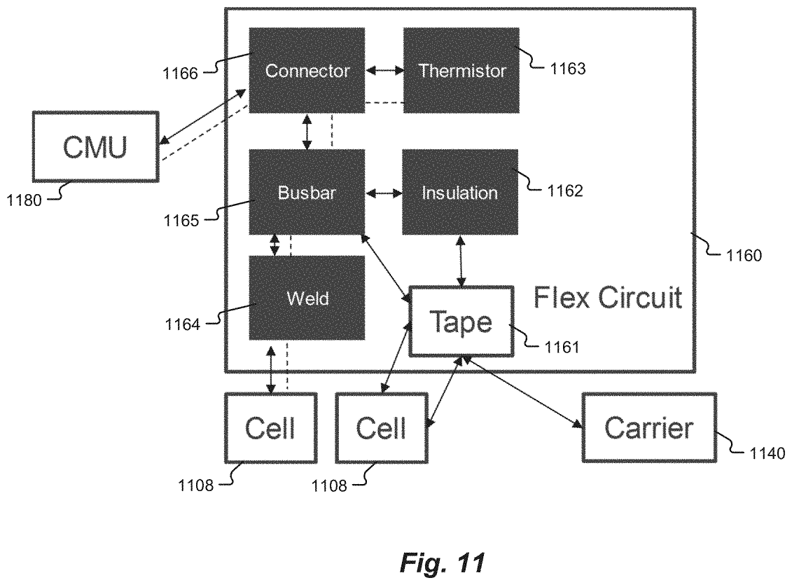

FIG. 11 shows flex circuit mechanical and electrical connections in accordance with embodiments of the present disclosure. The flex circuit 1160 includes tape 1161 (as a mechanical connection) and welds 1164 (as part of the electrical connections). Electrical connections may also be made by contact between conductive elements and wiring. The flex circuit 1160 also includes insulation 1162 that provides electrically insulative properties, a busbar 1165 to provide electrical conduction and upon which power is concentrated for distribution, a thermistor 1163 that is an electrical resistor used for measurement and control by reducing its resistance by heating, and a connector 1166 that senses voltage distributes power from the busbar 1165 to the CMU 1180 and the thermistor 1163.

In FIG. 11, the dotted line between elements denotes an electrical connection and the solid line with arrows between elements denotes a mechanical connection. Thus, for example, there are mechanical connections between the cells 1108 and the tape 1161 and the weld 1164 that are within the flex circuit 1160. Within the flex circuit 1160, there are mechanical connections between the tape 1161 and insulation 1162, the tape 1161 and busbar 1165, the weld 1164 and the busbar 1165, the insulation 1162 and the busbar 1165, the busbar 1165 and the connector 1166, and the connector 1166 and the thermistor 1163. There is also a mechanical connection between the CMU 1180 and the connector 1166 that is within the flex circuit 1160. There is an electrical connection between the cells 1108 and the weld 1164 that is within the flex circuit 1160. Within the flex circuit 1160, there are also electrical connections between the weld 1164 and the busbar 1165, the busbar 1165 and the connector 1166, and the connector 1166 and the thermistor 1163. Thus, the flex circuit 1160 may advantageously have temperature sensing integrated into the flex circuit 1160. In addition, there is an electrical connection between the CMU 1180 and the connector 1166 that is within the flex circuit 1160.

The flex circuit 1160 is used to connect battery cells electrically in parallel and/or in series, to provide a dielectric barrier (e.g., via the tape 1161 and the insulation 1162), to provide a temperature sensing interface (e.g., via the thermistor 1163), to provide a voltage sensing interface (e.g., via the connector 1166), and to provide fixturing for laser welding (e.g., weld 1164). In various embodiments, additional insulation may be used after the welding of the flex circuit 1160 to the cells 1108 to electrically insulate the components of the module, except for the module terminals. The low profile of the flex circuit 1160 may advantageously improve the volumetric packaging efficiency of the module.

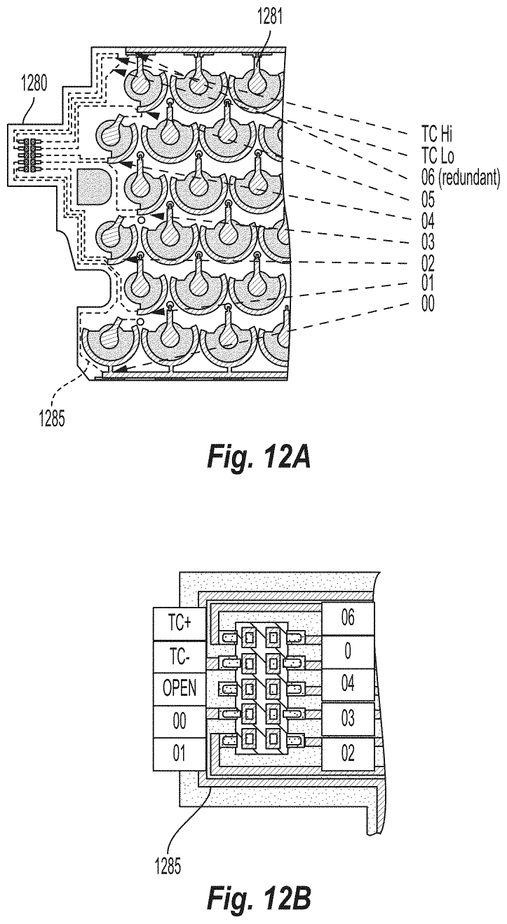

FIG. 12A is an illustrative diagram of portions of a flex circuit in accordance with embodiments of the present disclosure. The low side CMU 1280 is shown, which monitors and manages the module using circuit wiring 1285 (only one wiring is labeled for clarity) connected to low voltage connections and high voltage connections, and in FIG. 12A, an illustrative low side CMU connection diagram is shown. Fuses 1281 (only one is labeled in FIG. 12A for clarity) are in electrical contact with the cells, with one fuse being provided for each cell. Other electrical components may be included in the flex circuit, such as a voltage monitor for each cell. The circuitry wiring 1285 for the flex circuit is connected to circuitry within the CMU 1280, which monitors the system via the electrical connections for variables that may include, but are not limited to, temperature, voltage, and power usage. The CMU 1280 may also balance cell usage by monitoring voltage and power usage through the flex circuit and perform other functions.

FIG. 12B is an illustrative schematic of flex circuit connector pinouts in accordance with embodiments of the present disclosure. The flex circuit connector pinouts correspond to the low side CMU shown in FIG. 12A. The pinout connections are labeled according to their respective connections.

The exemplary systems and methods of this disclosure have been described in relation to a battery module and a number of battery cells in an electric vehicle energy storage system. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others. In some embodiments, the present disclosure provides an electrical interconnection device that can be used between any electrical source and destination. While the present disclosure describes connections between battery modules and corresponding management systems, embodiments of the present disclosure should not be so limited.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a battery module, comprising: energy storage cells, each of the energy storage cells having a top side and a bottom side, wherein each of the energy storage cells is arranged adjacent to another of the energy storage cells, and wherein the top sides of each of the energy storage cells are adjacent to one another; and a first coldplate comprising a first side, a second side opposite the first side, and an interior channel between the first side and the second side, wherein a bottom side of an energy storage cell in a first set of the energy storage cells is positioned alongside the first side of the first coldplate and a bottom side of an energy storage cell in a second set of the energy storage cells is positioned alongside the second side of the first coldplate.

Aspects of the above battery module include wherein a fluid within the interior channel is in thermal contact with the coldplate, and wherein the coldplate is in thermal contact with each of the energy storage cells in the first set and the second set.

Aspects of the above battery module further include a second coldplate, wherein the second coldplate comprises a first side, a second side opposite the first side, and an interior channel between the first side and the second side, wherein a bottom side of an energy storage cell in a third set of the energy storage cells is positioned alongside the first side of the second coldplate and a bottom side of an energy storage cell in a fourth set of the energy storage cells is positioned alongside the second side of the second coldplate.

Aspects of the above battery module include wherein the first coldplate is connected to the second coldplate by manifold jumpers.

Aspects of the above battery module include wherein the fluid flows from the first coldplate to the second coldplate through the manifold jumpers.

Aspects of the above battery module further include a third through a tenth coldplate, wherein the first through the tenth coldplates are each connected by manifold jumpers, and wherein the fluid flows in parallel through each of the first through the tenth coldplate through the manifold jumpers.

Aspects of the above battery module include wherein the third through the tenth coldplates comprise inner channels, wherein the first through the fifth coldplates are arranged with their channels extending adjacent to one another, wherein the sixth through the tenth coldplates are arranged with their channels extending adjacent to one another, and wherein the manifolds of the first through the fifth coldplates are adjacent to the manifolds of the sixth through the tenth coldplates.

Aspects of the above battery module include wherein at least some of the first through the tenth coldplates have rods extending through each of the at least some coldplates to mechanically connect the at least some coldplates.

Aspects of the above battery module include wherein the bottom side of the energy storage cell in the first set of the energy storage cells is adhered to the first side of the first coldplate and the bottom side of the energy storage cell in the second set of the energy storage cells is adhered to the second side of the first coldplate.

Aspects of the above battery module include wherein components of each of the coldplates are connected together with compression snaps.

Aspects of the above battery module include wherein the compression snaps each compress a compression limiter, and wherein the compression limiters limit a compressive load and limit a tensile load.

Embodiments include an energy storage device, comprising: energy storage cells, each of the energy storage cells having a top side and a bottom side, wherein sets of the energy storage cells are arranged in a pattern with the top sides of each of the energy storage cells being adjacent to one another; and a coldplate positioned between two of the sets of the energy storage cells, wherein the energy storage cells are mechanically connected to the coldplate on opposing sides of the coldplate.

Aspects of the above battery module include wherein the coldplate comprises outer plates in contact with a center channel plate, wherein the center channel plate comprises a channel for a fluid to circulate within the coldplate.

Aspects of the above battery module include wherein the outer plates are connected by compression snaps.

Aspects of the above battery module include wherein the compression snaps each compress a compression limiter, and wherein the compression limiters limit a compressive load and limit a tensile load.

Aspects of the above battery module include wherein the compression limiters are integral to the outer plates and wherein the compression snaps are integral to a carrier that encloses the coldplate and the energy storage cells.

Embodiments include a battery for an electric vehicle, comprising: a plurality of battery modules electrically interconnected with one another, wherein each battery module of the plurality of battery modules comprises: energy storage cells, each of the energy storage cells having a top side and a bottom side, wherein each of the energy storage cells is arranged adjacent to another of the energy storage cells, and wherein a top side of each of the energy storage cells is adjacent to a top side of another of the energy storage cells; and a first coldplate comprising a first side, a second side opposite the first side, and an interior channel between the first side and the second side, wherein a bottom side of an energy storage cell in a first set of the energy storage cells is positioned alongside the first side of the first coldplate and a bottom side of an energy storage cell in a second set of the energy storage cells is positioned alongside the second side of the first coldplate.

Aspects of the above battery module include wherein at least two of the battery modules are stacked adjacent to one another in a height direction, and wherein the at least two of the battery modules have a same width dimension and a same length dimension.

Aspects of the above battery module include wherein each of the battery modules has a size of about 355 inches by about 151 inches by about 108 inches.

Aspects of the above battery module include wherein an amount of the plurality of the battery modules is determined based on a physical size of the battery.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

The term “adhesive” refers to any substance applied to one surface, or both surfaces, of two separate items that binds them together and resists their separation. The adhesive may be non-reactive (e.g., drying, pressure sensitive, contact, or hot) or reactive (e.g., multi-part, pre-mixed, frozen, or one-part) and may be natural or synthetic. It can rely on one or more mechanisms of adhesion, such as a mechanical mechanism and/or chemical mechanism. The surface(s) to be bonded may be activated prior to adhesive application by any surface activation technique, such as plasma activation, flame treatment, and wet chemistry priming.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The term “chemical properties” refer to one or more of chemical composition, oxidation, flammability, heat of combustion, enthalpy of formation, and chemical stability under specific conditions.

The terms “determine,” “calculate,” “compute,” and variations thereof, as used herein, are used interchangeably and include any type of methodology, process, mathematical operation or technique.

The term “thermal properties” refer to one or more of thermal conductivity, thermal diffusivity, specific heat, thermal expansion coefficient, and creep resistance.

The term “electrical insulator” refers to a material or combination of materials whose internal electrical charges do not flow freely; very little electric current will flow through the material(s) under the influence of an electric field. Electrical insulators have higher resistivity than semiconductors or conductors. The electrical insulator material(s) may be natural or synthetic.

What is claimed is:

1. A battery module, comprising:
energy storage cells, each of the energy storage cells having a top side and a bottom side, wherein each of the energy storage cells is arranged adjacent to another of the energy storage cells, and wherein the top sides of each of the energy storage cells are adjacent to one another; and
a first coldplate comprising a first side, a second side opposite the first side, and an interior channel between the first side and the second side, wherein a bottom side of an energy storage cell in a first set of the energy storage cells is positioned alongside the first side of the first coldplate and a bottom side of an energy storage cell in a second set of the energy storage cells is positioned alongside the second side of the first coldplate.

2. The battery module of claim 1, wherein a fluid within the interior channel is in thermal contact with the coldplate, and wherein the coldplate is in thermal contact with each of the energy storage cells in the first set and the second set.

3. The battery module of claim 1, further comprising a second coldplate, wherein the second coldplate comprises a first side, a second side opposite the first side, and an interior channel between the first side and the second side, wherein a bottom side of an energy storage cell in a third set of the energy storage cells is positioned alongside the first side of the second coldplate and a bottom side of an energy storage cell in a fourth set of the energy storage cells is positioned alongside the second side of the second coldplate.

4. The battery module of claim 3, wherein the first coldplate is connected to the second coldplate by manifold jumpers.

5. The battery module of claim 4, wherein the fluid flows from the first coldplate to the second coldplate through the manifold jumpers.

6. The battery module of claim 3, further comprising a third through a tenth coldplate, wherein the first through the tenth coldplates are each connected by manifold jumpers, and wherein the fluid flows in parallel through each of the first through the tenth coldplate through the manifold jumpers.

7. The battery module of claim 6, wherein the third through the tenth coldplates comprise inner channels, wherein the first through the fifth coldplates are arranged with their channels extending adjacent to one another, wherein the sixth through the tenth coldplates are arranged with their channels extending adjacent to one another, and wherein the manifolds of the first through the fifth coldplates are adjacent to the manifolds of the sixth through the tenth coldplates.

8. The battery module of claim 6, wherein at least some of the first through the tenth coldplates have rods extending through each of the at least some coldplates to mechanically connect the at least some coldplates.

9. The battery module of claim 1, wherein the bottom side of the energy storage cell in the first set of the energy storage cells is adhered to the first side of the first coldplate and the bottom side of the energy storage cell in the second set of the energy storage cells is adhered to the second side of the first coldplate.

10. The battery module of claim 8, wherein components of each of the coldplates are connected together with compression snaps.

11. The battery module of claim 10, wherein the compression snaps each compress a compression limiter, and wherein the compression limiters limit a compressive load and limit a tensile load.

12. An energy storage device, comprising:
energy storage cells, each of the energy storage cells having a top side and a bottom side, wherein sets of the energy storage cells are arranged in a pattern with the top sides of each of the energy storage cells being adjacent to one another; and
a coldplate positioned between two of the sets of the energy storage cells, wherein the energy storage cells are mechanically connected to the coldplate on opposing sides of the coldplate.

13. The energy storage device of claim 12, wherein the coldplate comprises outer plates in contact with a center channel plate, wherein the center channel plate comprises a channel for a fluid to circulate within the coldplate.

14. The energy storage device of claim 13, wherein the outer plates are connected by compression snaps.

15. The energy storage device of claim 13, wherein the compression snaps each compress a compression limiter, and wherein the compression limiters limit a compressive load and limit a tensile load.

16. The energy storage device of claim 14, wherein the compression limiters are integral to the outer plates and wherein the compression snaps are integral to a carrier that encloses the coldplate and the energy storage cells.

17. A battery for an electric vehicle, comprising:
a plurality of battery modules electrically interconnected with one another, wherein each battery module of the plurality of battery modules comprises:
energy storage cells, each of the energy storage cells having a top side and a bottom side, wherein each of the energy storage cells is arranged adjacent to another of the energy storage cells, and wherein a top side of each of the energy storage cells is adjacent to a top side of another of the energy storage cells; and
a first coldplate comprising a first side, a second side opposite the first side, and an interior channel between the first side and the second side, wherein a bottom side of an energy storage cell in a first set of the energy storage cells is positioned alongside the first side of the first coldplate and a bottom side of an energy storage cell in a second set of the energy storage cells is positioned alongside the second side of the first coldplate.

18. The battery module of claim 17, wherein at least two of the battery modules are stacked adjacent to one another in a height direction, and wherein the at least two of the battery modules have a same width dimension and a same length dimension.

19. The battery module of claim 17, wherein each of the battery modules has a size of about 355 inches by about 151 inches by about 108 inches.

20. The battery module of claim 17, wherein an amount of the plurality of the battery modules is determined based on a physical size of the battery.
